(19) United States
(12) Patent Application Publication
(10) Pub. No.: US 2022/0011238 A1
(43) Pub. Date: Jan. 13, 2022

(54) METHOD AND SYSTEM FOR CHARACTERIZING SURFACE UNIFORMITY

(71) Applicant: 3M INNOVATIVE PROPERTIES COMPANY, St. Paul, MN (US)

(72) Inventors: Francis T. Caruso, Hudson, WI (US); Jeffrey K. Eliason, Woodbury, MN (US); David L. Hofeldt, Oakdale, MN (US); Joseph E. Hernandez, Farmington Hills, MI (US); Joshua A. Gullickson, St. Paul, MN (US)

(21) Appl. No.: 17/309,068

(22) PCT Filed: Nov. 13, 2019
(86) PCT No.: PCT/IB2019/059744

§ 371 Date: Apr. 20, 2021

Related U.S. Application Data
(60) Provisional application No. 62/767,407, filed on Nov. 14, 2018.

(51) Int. Cl. G01N 21/84; G01N 21/95; G01N 21/55; G06T 7/00

(52) U.S. Cl. CPC G01N 21/8422; G01N 21/95; G06T 2207/20048; G06T 7/0002; G01N 2021/9511; G01N 21/55

(57) ABSTRACT

A method includes emitting light from a light source (12) onto an at least partially reflective surface (24). The reflected light (30) is collected from the surface at a screen (32) to capture the intensity distribution (34) of the reflected light with a camera (40) in a first image (42). The intensity distribution of the first image of the reflected light is processed (50) by performing suitable filtering of a Fourier transform of the intensity distribution of the reflected light so as to emphasize features having an intensity variation of interest. The features of the intensity distribution of the reflected light having the variation of interest are analyzed to determine a uniformity value for the surface.

### BACKGROUND

A selected physical attribute of a material can be analyzed to determine the uniformity of the material, which in turn can provide useful information regarding the appearance and functionality of the material in a particular product application. Methods for analyzing and determining uniformity have relied on pictorial standards and the judgment of human experts, but such qualitative methods lack precision and cannot be utilized in real-time as a product is manufactured.

Optical methods have been used to measure physical properties of materials in real-time. However, rapidly evaluating the overall uniformity of a material based on these measurements has proven to be difficult, as some non-uniformities are present at small size scales, while others are apparent only at larger size scales.

### SUMMARY

In general, the present disclosure is directed to a method for characterizing the uniformity of a surface of an optical component, wherein the surface is at least partially reflective. The method processes a reflected intensity distribution of an external or internal surface of the optical component, and the process information obtained can be used to quantify a selected feature therein. For example, using the method of the present disclosure, the severity of distortion in the surface of the optical component such as mottle may be quantified by an optical inspection system. In some embodiment, the methods of the present disclosure may be used to evaluate the surface of an optical component in real time as the optical component is manufactured.

The quantitative information about the selected features obtained by the optical inspection system is more accurate and reproducible compared to qualitative human evaluations of defect severity. The optical inspection system may be used to establish and maintain quality standards for the optical component, and optical components failing to meet quality standards may be removed from the manufacturing process prior to incorporation into more complex optical systems such as, for example, displays used in automotive and aerospace applications.

For example, qualitative ratings of defects that arise in the manufacturing of reflective polarizer films such as mottle, orange peel, and the like, have been found to be unreliable and unrepeatable, even when performed by human experts visually analyzing the surfaces of the films, and a quantitative measurement system is needed to ensure quality standards are met and maintained. A compact area-camera based optical inspection system including the methods and apparatus of the present disclosure utilizes light reflected from surfaces of the reflective polarizer film to quantitatively rate the severity of a selected type of defect on a selected surface of the reflective polarizer, while minimizing or even eliminating the contribution of other types of defects or the contribution of other interfaces in the sample under test. In various embodiments, the inspection system of the present disclosure can utilize image processing techniques such as, for example, the combination of Fourier transform filtering and patch-based uniformity metrics, to provide a robust quantitative defect rating of a surface at various size scales that is independent of human error resulting from visual analysis of the surface. The inspection system of the present disclosure can provide information to determine product formulation, to evaluate construction and specification for products, or to test a laminated product.

By viewing the surface of the optical component in reflection, in some embodiments polarization effects can be used to optimize reflections from selected layers of the optical component, as well as enable the inspection of layers that reside above opaque layers in the optical component. In reflective geometry, the exact angle of incidence does not affect the sensitivity of the measurement to variations in surface slope, but by choosing the polarization state of the incident beam (or analyzing the reflected beam with a polarizer), unwanted surface reflections within stacked laminates can be eliminated, leaving only reflections from the selected surface of the optical component under test.

In one aspect, the present disclosure is directed to a method, including: emitting light from a light source onto a surface, wherein the surface is at least partially reflective; collecting reflected light reflected from the surface to capture the intensity distribution of the reflected light; processing the intensity distribution of the reflected light to emphasize features of the intensity distribution of the reflected light having a variation of interest; and analyzing the features of the intensity distribution of the reflected light having the variation of interest to determine a uniformity value for the surface.

In another aspect, the present disclosure is directed to a method, including: emitting light from a point light source onto a surface of an optical component, wherein the surface is at least partially reflective; collecting reflected light from the surface on a screen to capture an intensity distribution of the reflected light; imaging the screen with a camera to form an image of the intensity distribution of the reflected light; performing a Fourier transform of the image of the intensity distribution of the reflected light; filtering the Fourier transform to obtain a filtered Fourier transform, wherein the filtering selects spatial frequencies in the image of the intensity distribution indicative of a defect in the surface; performing an inverse Fourier transform of the filtered Fourier transform to obtain an inverse Fourier transform; analyzing regions of the inverse Fourier transform to determine contrast variations within the regions; and calculating uniformity values for the defect in each region of the inverse Fourier transform.

In another aspect, the present disclosure is directed to a system for determining the uniformity value for a surface of an optical component, the system including an optical component including an at least partially reflective surface; and an apparatus, the apparatus including: a point source emitting light onto the surface of the optical component; a screen positioned to collect reflected light reflected from the surface of the optical component and capture an intensity distribution of the reflected light; a camera positioned to image the screen and capture an image of the intensity distribution of the reflected light; and a computer with a processor configured to: perform a Fourier transform of the image of the intensity distribution of the reflected light; filter the Fourier transform to obtain a filtered Fourier transform, wherein the filter is applied to select spatial frequencies in the image of the intensity distribution indicative of a defect in the surface; perform an inverse Fourier transform of the filtered Fourier transform to obtain an inverse Fourier transform; analyze regions of the inverse Fourier transform to determine contrast variations within the regions; and calculate uniformity values for the defect for each region of the inverse Fourier transform.

The terms “about” or “approximately” with reference to a numerical value, property, or characteristic, means +/−five percent of the numerical value, property, characteristic, but also expressly includes any narrow range within the +/−five percent of the numerical value or property or characteristic as well as the exact numerical value. For example, a temperature of “about” 100° C. refers to a temperature from 95° C. to 105° C., inclusive, but also expressly includes any narrower range of temperature or even a single temperature within that range, including, for example, a temperature of exactly 100° C.

The term “substantially” with reference to a property or characteristic means that the property or characteristic is exhibited to within 98% of that property or characteristic, but also expressly includes any narrow range within the two percent of the property or characteristic, as well as the exact value of the property or characteristic. For example, a substrate that is “substantially” transparent refers to a substrate that transmits 98-100%, inclusive, of the incident light.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic side view of an example optical inspection system that can be configured to use the surface analysis methods of the present disclosure.

FIG. 2 is a schematic side view of an example optical inspection system that can be configured to use the surface analysis methods of the present disclosure.

FIGS. 3A-3B are schematic overhead views of Fourier transform filters that can be used to emphasize or deemphasize defects in an image obtained using the optical inspection systems of the present disclosure.

FIGS. 4A-4B are schematic overhead views of Fourier transform filters that can be used to emphasize or deemphasize defects in an image obtained using the optical inspection systems of the present disclosure.

FIGS. 5A-5B are schematic overhead views of Fourier transform filters that can be used to emphasize or deemphasize defects in an image obtained using the optical inspection systems of the present disclosure.

FIG. 6 is a table showing examples of Fourier transform filters and the feature of an image that is emphasized or deemphasized by use of the filter.

FIG. 7 is a flow chart of an example of the surface analysis method of the present disclosure.

FIG. 8 is a flow chart of an example of the surface analysis method of the present disclosure.

FIG. 9 is a flow chart of an example of the surface analysis method of the present disclosure.

FIGS. 10A-10C are plots of orange peel defect ratings for the reflective polarizer films of Example 1, as taken by expert human appraisers.

FIG. 11A is a plot comparing large scale mottle ratings for the reflective polarizer films of Example 2 as determined by the method of the present disclosure vs. ratings determined by the expert human appraisers.

FIG. 11B is a plot comparing orange peel and large scale mottle uniformity ratings for the reflective polarizer films of Example 2.

Like symbols in the drawings indicate like elements.

### DETAILED DESCRIPTION

In one aspect, the present disclosure describes a method and system for inspecting and rating the uniformity of an at least partially reflective internal or external surface of a component. Light emitted by a light source is reflected from a selected surface on or within the component, and the intensity distribution of the light reflected from surface is captured. The intensity distribution of the reflected light, which includes spatial variations in contrast, is then processed to emphasize features of the intensity distribution having a feature or variation of interest. Image processing methods including, but not limited to, application of Fourier transform filtering, wavelet methods, spatial convolutions, and combinations thereof, are employed to emphasize or deemphasize different size scales, orientations, and/or defects in the image, while retaining quantitative information about the original contrast of the isolated size scales or features. A uniformity algorithm is then applied to evaluate the severity of the variations in contrast associated with the size scale(s) and feature(s) selected by the image processing method.

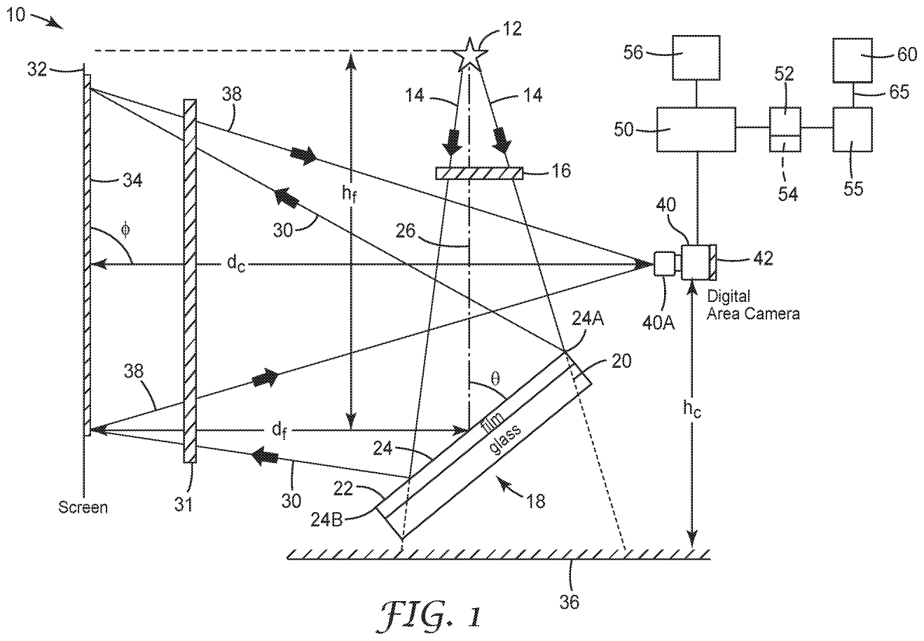

FIG. 1 is a schematic illustration, which is not to scale, of an embodiment of an optical inspection system 10 that may be used to implement the surface inspection methods of the present disclosure. The optical inspection system 10 includes a light source 12 emitting light rays 14 (only marginal light rays shown for clarity) onto a sample under test 18, which is located a distance h_{f} from the light source 12. The light source 12 should be configured to emit a well-defined wave front, and is positioned relative to the sample 18 such that any point on the sample 18 subtends a narrow range of angles bounded by all of the rays that strike it from the light source 12. In various embodiments, the light source 12 may be a spatially coherent light source, and in some embodiments is a point light source. In some embodiments, the optical inspection system 10 further includes an optional polarizer 16, which polarizes the light 14 emitted from the light source 12 before the emitted light 14 contacts the sample under test 18.

In the embodiment of FIG. 1, the sample under test 18 includes a substrate 20 having an optical component 22 (for example, a polymeric optical film such as a reflective polarizer film, diffuser, absorbing polarizer) thereon. In some examples, the optical component 22 can optionally be laminated to the substrate 20 with a layer of an adhesive (not shown in FIG. 1) such as, for example, an optically clear adhesive. In the embodiment of FIG. 1, the optical component 22 includes an external surface under test 24 that is at least partially reflective for the wavelengths of the light 14 emitted by the light source 12. In some embodiments, the surface under test 24 is highly reflective for the light 14 from the light source 12.

The reflected light rays 30 reflected from the surface under test 24 (only marginal rays shown for clarity) are directed toward an image plane 32, where an intensity distribution 34 of the surface under test 24 is captured. The image plane 32 in the embodiment of FIG. 1 is a screen, but in other embodiments the intensity distribution 34 of the surface 24 may be formed, for example, by a component of an optical system such as a lens, in a camera (for example, a CCD camera or on a CMOS array), on a focal plane array (FPA), and the like.

In one embodiment, the reflected rays 30 may be at least be partially polarized after reflecting from the surface 24. In some embodiments, an optional optical component 31 such as a lens array may be used to condense the reflected rays 30 prior to capture of the intensity distribution 34. In some embodiments, the optical component 31 may be used to analyze at least one of the reflected beam 30 or light rays 38 reflected from the captured intensity distribution 34 to, for example, adjust the polarization of the light rays, reduce undesirable background reflections from the surface 24, and the like. In some embodiments, the quality of the captured intensity distribution 34 may optionally be enhanced by placing the sample under test 18 against a non-reflective surface such as, for example, a black screen 36.

Referring again to FIG. 1, light rays 38 reflected from the captured intensity distribution 34 (only marginal light rays shown for clarity) of the surface 24 on the screen 32 may optionally be further imaged by a camera (for example, a digital area scan camera) or imaging array 40 focused to form therein a first image 42 of the intensity distribution 34 on the screen 32. To most effectively collect the reflected light rays 38 from the center of the screen 32, the camera 40 may be positioned a distance d_{c} from the image collection point 32 and a distance h_{c} from the non-reflective surface 36. The camera 40 may be oriented at any suitable angle ϕ with respect to the screen 32, and in some embodiments ϕ is substantially equal to 90°.

In the embodiment of FIG. 1, the optical component 18 is tilted at an angle θ with respect to the center 26 of the light source 12 so that the intensity distribution 34 of the surface under test 24 is captured near the center of the screen 32. In various embodiments the angle θ ranges from about 0° to about 60°, or from about 30° to about 55°, or from about 35° to about 55°. In various embodiments, any of the tilt angle θ, the distance d_{f} between the surface 24 and the intensity distribution capture point 32, or the distance h_{f} from the light source 12 to the surface 24, may be selected such that selected features on, or areas of, the surface 24 in the first image 34 are of sufficient size to permit further analysis of a selected defect in the surface 24. For example, in some embodiments, any of the tilt angle θ, the distance d_{f} between the surface 24 and the screen 32, the distance h_{f} from the light source 12 to the surface 24, and the tilt of the screen 32 may be selected to select a path length of the reflected light rays 30, to correct distortions in the intensity distribution 34, or to change the ranges of angles subtended by the surface 24 and the image collection point 32, to set the sensitivity of the system 10 and its ability to capture and resolve a feature of interest in the surface 24.

For example, in FIG. 1, in some embodiments a difference in optical path length along the rays 30 reflected from the top 24A and bottom 24B of the surface 24 can cause the magnification of features on the surface 24 in the intensity distribution 32 to vary from the bottom to the top of the collection point wherein the intensity distribution is captured (for example, screen 32 in FIG. 1), which can also be referred to as keystone distortion. For example, a rectangular sample including the surface 24 will give rise to a trapezoidal projected reflected first image 34 on the screen 32.

In some embodiments, this vary magnification may not detract from the analysis of the intensity distribution 34, as it may not be necessary for a particular application to provide high resolution of size scales or to provide a continuous distribution of size scale uniformity metrics for process feedback and quality control applications. However, in some embodiments, to maintain or improve the accuracy of size scales across the entire region viewed on the intensity distribution of light reflected from the surface 24, several optional techniques may be used (individually or in combination). For example, in some embodiments, the screen 32 and the camera 40 may be tilted such that all rays 30 reflecting from the surface 24 have substantially matching path lengths while the camera 40 remains substantially normal to the imaging screen (ϕ=90°). In another embodiment, a lens system 40A in the camera 40 such as, for example, a tilt/shift lens, may be used to tilt the first image 42 formed in the camera 40 to counteract the magnification changes in the projected intensity distribution 34. In another example, a lens system 40A including a standard imaging lens may be used while tilting the camera 40 off axis (ϕ≠90°) to remove the distortion in conjunction with closing the F-stop of the lens 40A of the camera 40 to ensure the entire first image 42 of the intensity distribution 34 remains in focus within the camera 40. In another embodiment, a processor 54 in a digital computer 52 may be configured with appropriate software to map the distortion present in the captured intensity distribution 34 and be corrected spatially in the first image 42 captured by the camera 40.

In some embodiments, after the first image 42 is acquired by the camera 40, prior to application of further image processing algorithms, the image 42 may optionally be calibrated, and the image intensities mapped according to the calibration. The first image 42 obtained by the camera 40 in FIG. 1 shows intensity values in pixellated form, and in some embodiments these intensity values be made constant to take into account, for example, differing levels of output from the light source 12, or varying reflectivity of the surface 24. Since the uniformity values depend on measured intensities, maintaining stable and repeatable mappings from the screen 32 to pixel intensity in the first image 42 can provide enhanced accuracy over time on a given inspection system and between different inspection systems.

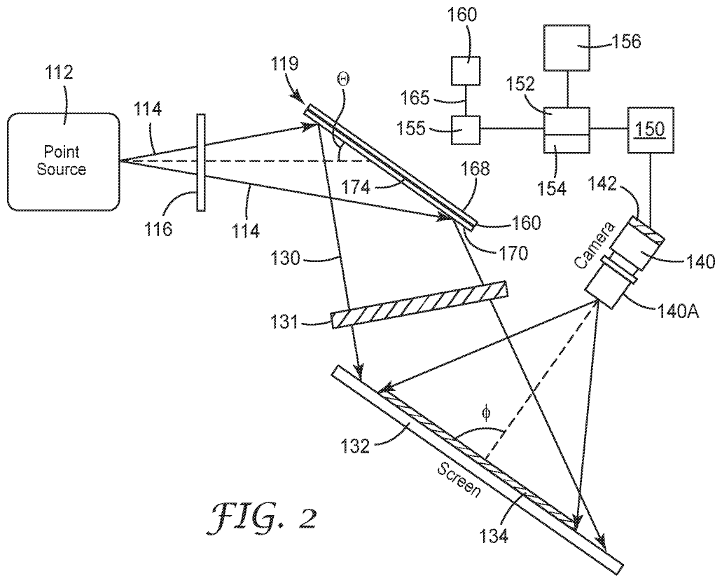

In another example embodiment shown in the simplified schematic diagram of FIG. 2, which is not to scale, a laminate construction 119 under test includes an optical component 160 that resides between a first substrate 168 and a second substrate 170. At least one of the first substrate 168 and the second substrate 170 should transmit light rays 114 emitted from a light source 112, and in the embodiment of FIG. 2 at least the second substrate 170 should be transparent. In some embodiments, the optical component 160 may be laminated between the substrates 168, 170 using an adhesive such as, for example, an optically clear adhesive (not shown in FIG. 2). The laminate construction 119 is tilted at an angle θ with respect to a center of the point light source 112. In the embodiment of FIG. 2, the angle θ ranges from about 0° to about 60°, or from about 30° to about 55°, or from about 35°to about 55°.

In the example embodiment of FIG. 2, the optical component 160 includes at least one partially reflective surface 174, which is an interior surface of the laminate construction 119. In some embodiments, the optical component 160 may itself include multiple layers, and the surface 174 may be a selected interior layer of the optical component 160. The light rays 114 emitted by the light source 112 (only marginal rays shown for clarity) pass through an optional polarizer 116 and enter the laminate construction 119. To reach the surface 174 between the substrates 168, 170, the light rays 114 must traverse multiple interfaces. Reflected light rays 130 reflected from the surface 174 must again traverse multiple interfaces while leaving the sample 118 and prior to forming the intensity distribution 134 on the screen 132. Since multiple layers within the laminate construction 119 contribute reflections to the intensity distribution 134, the intensity distribution 134 includes the superposition of the reflections from each interface. The intensity distribution 134 is then imaged by a camera 140 with lens 140A to form a first image 142 of the intensity distribution 134.

Optical techniques and additional image analysis may be used to separate the contributions from different layers in the image 134. For example, polarization filtering of the light emitted by the light source 112 by the polarizer 116, polarization or condensation of the reflected light 130 by the optical system 131, or both, may be used to adjust the polarization of the reflected light 130, or to reduce reflections from the multiple interfaces in the laminate construction 119 that are not of interest in the evaluation of the surface 174.

In some embodiments, to maintain or improve the accuracy of size scales across the entire region viewed on the surface 174, any of the techniques discussed above with respect to

FIG. 1 may be used (individually or in combination). For example, in some embodiments, the screen 132 and the camera 140 may be tilted such that all rays 130 reflecting from the surface 124 have substantially matching path lengths while the camera 140 remains substantially normal to the imaging screen (ϕ=90°). In another embodiment, the camera 140 can be placed off axis from the screen 132 (ϕ≠90°) and an aperture in the camera lens 140A stopped down to increase the depth of field of the lens 140A, which can help to resolve magnification changes across the screen 132 and ensure the entire first image 142 of the intensity distribution 134 remains in focus within the camera. In another embodiment, the lens 140A in the camera 140, such as a tilt/shift lens, may be used to tilt the first image 142 formed in the camera 140 to counteract the magnification changes in the intensity distribution 134. In another embodiment, software in a digital computer 152 may be configured to map the distortion present in the projected image 134 and be corrected spatially in the second image 142 captured by the camera 140.

The images 42, 142 captured by both of the hardware configurations described above in FIGS. 1-2 contain intensity variations that vary in both size and orientation. In the methods of the present disclosure, these variations can be separated across different spatial frequencies and orientations to provide quantitative metrics on separate types of variations including, but not limited to, horizontal chatter, vertical banding, small scale mottle (orange peel), and large scale mottle.

Referring to FIG. 1 for simplicity, to process the intensity distribution 34 of the surface 24 embodied in the first image 42, or in a second image derived from the first image 42 (not shown in FIG. 1), a device 50 emphasizes selected features of the intensity distribution of the surface 24 having a variation of interest. In some embodiments, the processed intensity distribution 34 can be further analyzed in the digital computer 52 having the processor 54 configured with image analysis software, or may optionally be displayed on a suitable user interface 56.

For example, in the embodiment of FIG. 1, the device 50 may filter the first image 42, apply wavelet methods to the first image 42, perform spatial convolutions, utilize machine learning algorithms, or any combination thereof, to emphasize selected features of the first image 42 representing a defect of interest in the surface 24.

In one embodiment which is used herein for illustrative purposes, and which is not intended to be limiting, the device 50 performs a two-dimensional (2D) Fourier transform of the first image 42. In the embodiment of FIG. 1, the device 50 may perform the Fourier transform of the first image 42 with hardware such as an optical system with an arrangement of lenses (not shown in FIG. 1), in a device such as a field programmable gate array (FPGA), or may utilize the digital computer 52 with the processor 54 including software configured to take the Fourier transform of the first image 42. In some embodiments, the processor 54 may optionally display the Fourier transform of the first image 42 on the user interface 56.

A filter may be applied to the 2D Fourier transform to modify the frequency content to emphasize a variation of interest within the first image 42, to de-emphasize an unwanted variation of interest within the first image 42, or to select a given size scale within the first image 42 that contains the variation of interest. Suitable variations of interest that can be emphasized or deemphasized within the first image 42 include, but are not limited to, regions of the first image 42 indicative of horizontal chatter, vertical banding, small scale mottle (orange peel), large scale mottle, and the like. In some embodiments, the filters may optionally be blurred using a convolution filter to smooth the edge transition from 1 to 0 to eliminate ringing artifacts that would arise if Fourier-domain filters with sharp step changes were applied. For example, the convolution may be performed with a box linear filter used to create the blurring effect, and the size and number of iterations of the blurring filter were applied to smooth the edge transitions. Additional filters can be applied to achieve a desired level of blurring while eliminate ringing artifacts.

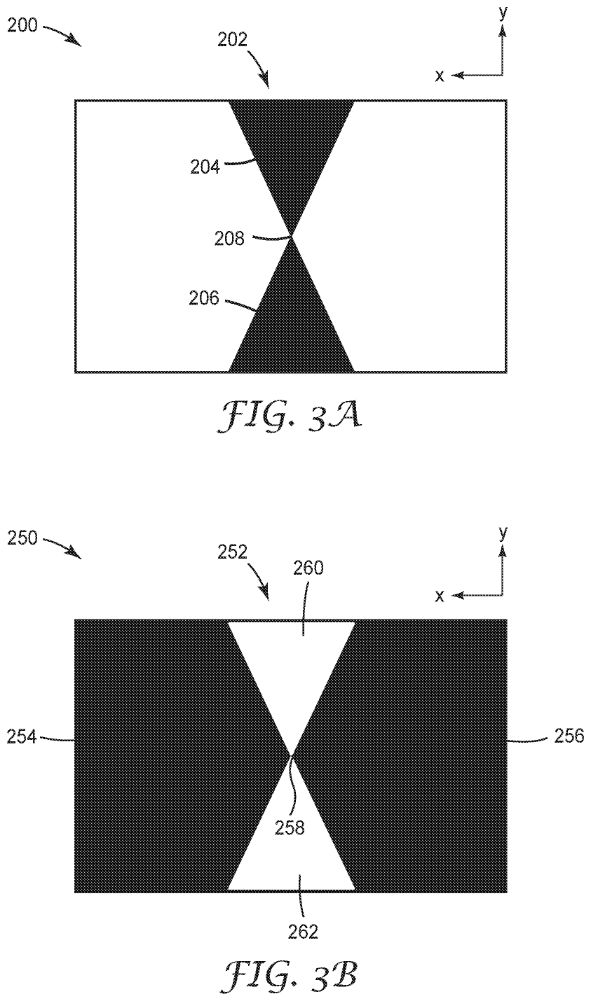

Examples of spatial frequency filters that can be applied to the 2D Fourier transform to emphasize or deemphasize regions within the first image 42 are shown in the FIGS. 3-5 below. In the filter examples discussed below, all white areas of filter are essentially kept unmodified, whereas spatial frequencies associated with black areas are reduced or otherwise removed from further analysis. A dashed border has been added so that the filters have a finite domain, and to distinguish them from the white of the page. Points near the center of the filter image are low spatial frequencies, while those near the edges are high spatial frequencies. As shown below, filter features in the vertical direction affect horizontal spatial variations (and similarly horizontal filter features affect vertical spatial variations). By adjusting the size and orientation of the filter features, particular ranges of spatial scales and orientations can be selected in the first image 42.

Referring to the example depiction of the filter in FIG. 3A, to deemphasize or remove horizontal banding in the image 42, a filter 200 includes a geometric feature 202 that tapers toward a center of the 2D Fourier transform of the image 42. The geometric feature 202 includes a first triangular filter region 204 and a second triangular region 206 that is a rotation of the first triangular filter region 204 about a center pixel 208 of the 2D Fourier transform of the first image 42. To most effectively deemphasize horizontal banding in the first image 42, the triangular filter regions 204, 206 are substantially aligned along the y-axis of the 2D Fourier transform of the first image 42 as shown in FIG. 3A. In the filter of the embodiment of FIG. 3A, the center pixel 208=0 frequency, but in other embodiments another frequency could be selected at the center pixel 208.

Referring to another example filter in FIG. 3B, to emphasize or isolate horizontal banding in the image 42, the filter 250 includes a first pentagonal filter region 254 and a second pentagonal region 256 that is a rotation of the first pentagonal filter region 254 about a center pixel 258 of the 2D Fourier transform of the first image 42. The pentagonal filter regions 254, 256 form an open geometric feature 252 including triangular open regions 260, 262 meeting at the center pixel 258 and arranged along the y-axis of the 2D Fourier transform.

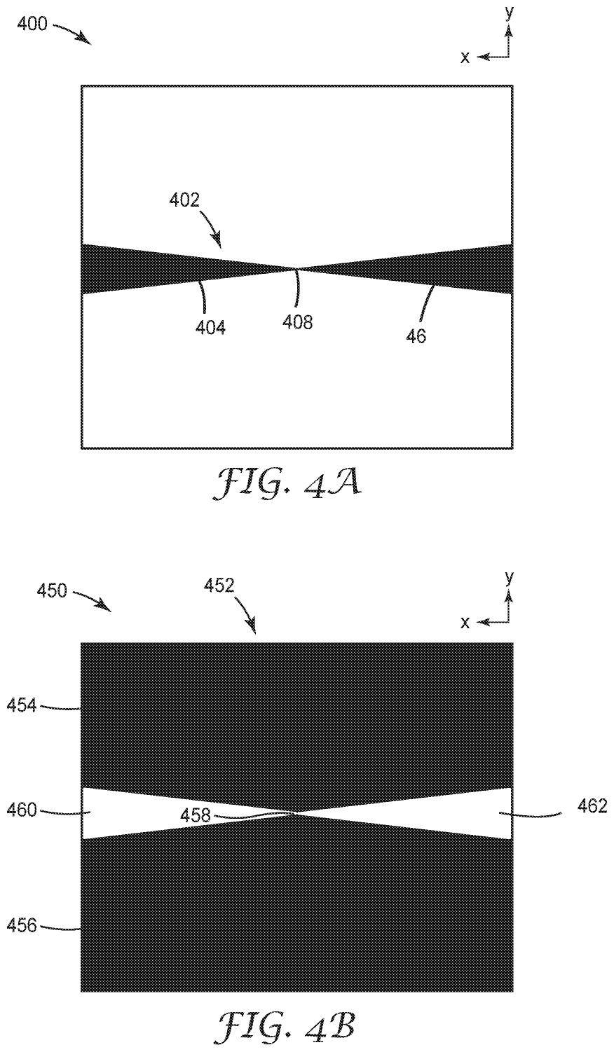

Referring to FIG. 4A, to deemphasize or remove vertical banding in the image 42, a filter 400 includes a geometric feature 402 that tapers toward a center of the 2D Fourier transform of the first image 42. The geometric feature 402 includes a first triangular filter region 404 and as second triangular filter region 406 that is rotated about a center pixel 408 of the 2D Fourier transform of the first image 42. To most effectively deemphasize vertical banding in the image 42, the triangular filter regions are substantially aligned along the x-axis of the 2D Fourier transform of the image 42.

Referring to FIG. 4B, to emphasize or isolate vertical banding in the image 42, the filter 450 includes a geometric feature 452 that tapers toward a center of the 2D Fourier transform of the image 42. The geometric feature 452 includes a first pentagonal filter region 454 and a second pentagonal region 456 that is rotated about a center pixel 458 of the 2D Fourier transform of the first image 42. The pentagonal regions 454, 456 form triangular open regions 460, 462 meeting at the center pixel 458 and aligned substantially along the x-axis of the 2D Fourier transform of the image 42.

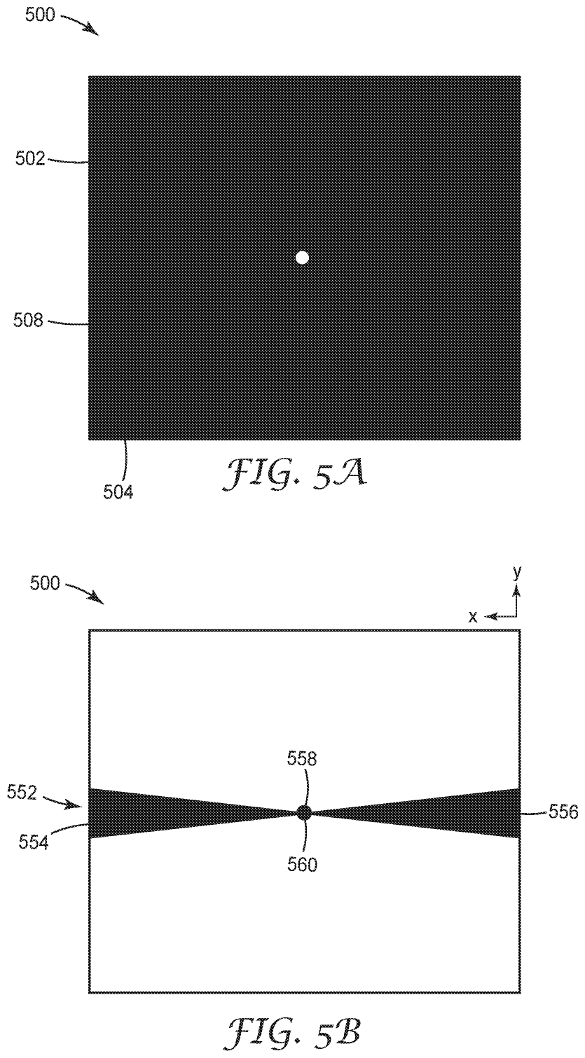

As shown in FIG. 5A, to emphasize or isolate larger-scale mottle in the image 42, a filter 500 includes an annulus 502 about the center pixel 508 of the 2D Fourier transform of the image 42. The annulus is generally rounded, and in various embodiments may be circular as shown in FIG. 5A, or elliptical. The annulus 502 is surrounded by a filter region 504, and forms a pinhole-like aperture in the filter region 504.

Referring to FIG. 5B, the emphasize or isolate smaller-scale mottle (also referred to as orange peel) in the image 42, a filter 550 includes a geometric feature 552 that tapers toward a center of the 2D Fourier transform of the image 42. The geometric feature 552 includes a first triangular filter region 554 and a second triangular filter region 556 that is rotated about a center pixel 558 of the 2D Fourier transform of the first image 42. To at least substantially remove low frequency component variations from the 2D Fourier transform of the first image 42, the geometric feature 552 further includes an annular region 560 about the center pixel 558. The annular region 560 is generally rounded, and in various embodiments may be circular as shown in FIG. 5B, or elliptical. To most effectively emphasize or isolate smaller-scale mottle in the first image 42, the triangular filter regions 554, 556 are substantially aligned along the x-axis of the 2D Fourier transform of the image 42.

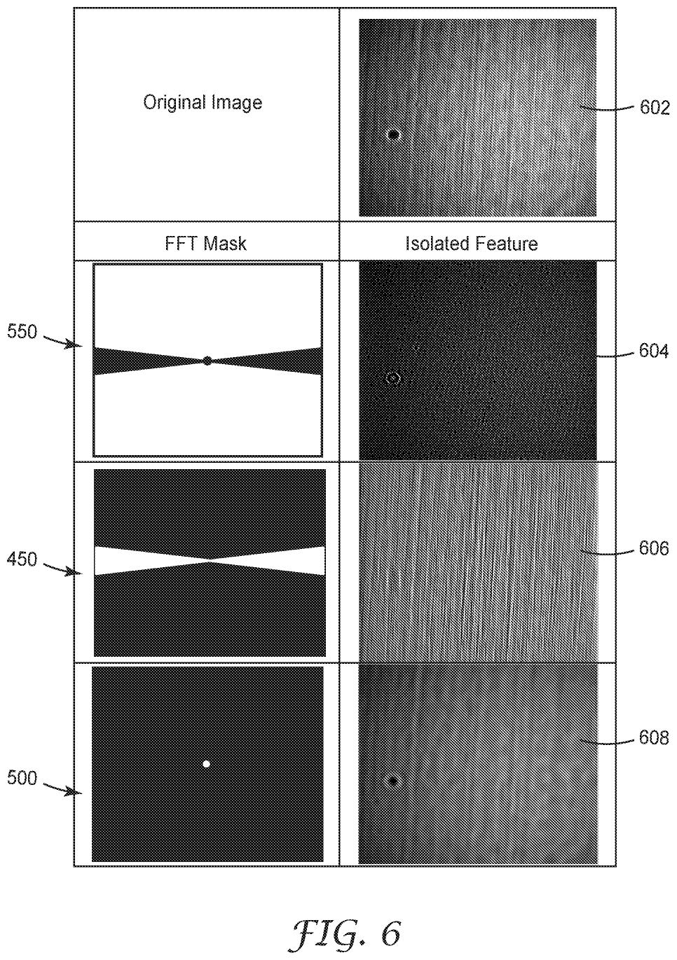

Following application of the filter to the 2D Fourier transform of the first image 42 to form a filtered image, in some embodiments the inverse 2D Fourier transform is taken of the filtered 2D Fourier transform image to reconstruct a modified image back in the spatial domain with either the unwanted artifact removed or to isolate variations in a given size range and/or orientation from the rest of the first image 42. FIG. 6 shows several examples of how the filters described in FIGS. 3-5 above may be used to isolate selected features in the first image 42 of the intensity distribution 34 of the surface 24 (FIG. 1).

In FIG. 6, a 2D Fourier transform is performed on a first image 602 of an intensity distribution of a selected surface, and the filter 550 of FIG. 5B is applied to the 2D Fourier transform with the low frequency content located at the center of the image. In a first example, an inverse 2D Fourier transform of the resultant filtered image is performed, which is shown in image 604. As can be seen from the image 604, the filter of FIG. 5B emphasizes smaller-scale mottle (orange peel) from the original image 602.

In another example, the filter 450 of FIG. 4B is applied to the 2D Fourier transform of the image 602, and then an inverse 2D Fourier transform of the resultant filtered image is performed, which is shown in image 606. As shown in the image 606, the filter of FIG. 4B emphasizes vertical banding in the image 602.

In another example, the filter 500 of FIG. 5A is applied to the 2D Fourier transform of the image 602, and then an inverse 2D Fourier transform of the resultant filtered image is performed, which is shown in image 608. As shown in the image 608, the filter of FIG. 5A emphasizes larger scale mottle features in the image 602.

In the method of the present disclosure, the reconstructed inverse 2D Fourier transform image (for example, the images 604-608 of FIG. 6) performed on the 2D Fourier transform image of the first image 42 of the intensity distribution 34 of the surface 24 is then analyzed to determine contrast variations within a region therein, and then uniformity values are calculated for each region. For example, the region may be broken into discrete patches of a given width and height to analyze a selected size scale of interest, and the interquartile range of the pixel values within the patches are calculated to quantify the occurrence of the variation of interest within the image.

For example, in applications where the region of the inverse Fourier transform is to be converted into small patches, a non-uniformity at a size scale much larger than these small patches may not have any cosmetic or functional impact, since it will not be visible within the extent of and single small patch. Larger-scale non-uniformities may cause differences in functional properties between samples. Or, since in some embodiments all of the unwanted frequencies in the image could be filtered out, and the patch size can be set to the size of the image to calculate a uniformity value. The above are just examples of the types of application-specific considerations that can be considered when choosing the range of size scales in the inverse Fourier transform over which to estimate uniformity. For example, a set of size scales at which to measure uniformity can be initially defined based on, for example, the type of material being analyzed, the size of the final product, and the like. For example, for a given application, an operator might wish to characterize uniformity at scales between 25 mm and 100 mm, in increments of 25 mm. In some embodiments, the scales may be graduated, and the graduations may be equal, non-equal, or random.

For example, for each of the predefined size scales, the processor 54 in the computer 52 may be configured with software to treat the 2D inverse Fourier transform image to remove and/or suppress the impact of non-uniformities that are much smaller than the size scale currently under consideration. This treatment step is referred to herein generally as low-pass filtering, and in some embodiments can suppress high frequencies in the image. In some embodiments, the low-pass filtering step performed by the processor 54 is equivalent to smoothing, but has theoretical interpretations in the frequency domain related to the 2D inverse Fourier Transform.

In some embodiments, the low pass filter is a “box filter,” which consists of a two-dimensional kernel consisting of identical values. When convolved with an image, the box filter replaces each pixel in the size scale under consideration with the average of all neighboring pixel values. In other embodiments, a two-dimensional Gaussian kernel low-pass filter may be used, which can have more favorable characteristics in the frequency domain. When convolved with an image, the two-dimensional Gaussian kernel replaces each pixel with a weighted average of the intensities of the surrounding pixels, where the weights are given by the Gaussian kernel.

Regardless of the type of low-pass filter selected for a particular application, the algorithm suppresses high-frequency components of the 2D inverse Fourier transform image, which consist of image features much smaller than the size scale of interest. The low-pass filter allows measurement of only non-uniformities that are roughly near the size scale of interest, which removes the effect in a given patch caused by non-uniformities at much lower size scales. The smaller non-uniformities are captured at smaller size scales in the multiscale processing algorithms.

The application of a low-pass filter can be thought of in terms of how an observer visually perceives non-uniformities when physically looking at a sample. That is, when the observer stands close to the sample, very fine details of the surface are apparent, but not the overall uniformity on a large scale. On the other hand, when the observer stands far away from the sample, the overall uniformity and variations dominate the image, but the observer can no longer detect the fine level of detail that may exist at smaller size scales. The method of the present disclosure allows for filtering of both larger or smaller size scales, which can be performed on the inverse Fourier transform, with a band pass filter, and the like.

For example, in each iteration of the low-pass filtering algorithm described above, the low-pass filter can be selected to have a cutoff frequency equal to a predefined fraction of the current size scale at which to measure uniformity. In one specific example, if the size scale under consideration corresponds to 100 pixels, a box filter with a width of 20 pixels might be selected to suppress non-uniformities that are outside the size scale of interest.

Once the 2D inverse Fourier transform image is filtered to remove or reduce the impact of image features that are non-essential to the uniformity analysis at the selected size scale, the image is divided into regions equal to the size scale of interest, referred to herein as patches. The image is divided into patches with a size equal to the current size scale of interest for measuring non-uniformities. A non-uniformity metric is subsequently computed on each patch, so this division has the effect of ensuring that information is not captured about non-uniformities at a larger size scale. Non-uniformities at finer size scales are suppressed through appropriate filtering as described above.

To calculate the non-uniformity of each patch, the processor applies a metric that characterizes the overall uniformity of the image of the patch in a quantitative and repeatable way. First, a small sub-image may be considered to be a function of two variables I(x,y), where x and y are indices of the pixel locations, and I(x,y) is the intensity of the pixel at location (x,y). Given this definition, simple statistical calculations can be used as a proxy for the uniformity (or (non-) uniformity) in the sub-image. For example, since in most cases a perfectly uniform patch is one in which all intensity values are equal, standard deviation of the patch is one straightforward choice for a metric. Given the patch I(x,y), the sample standard deviation can be computed as:

f_{std}=N−1ΣxΣy(I f₀(x,y)−μ(I))²,

where μ(I) is the mean intensity in the patch, and N is the total number of pixels in it.

Other possible uniformity metrics include inter-quartile range (IQR), median absolute deviation (MAD), and the information entropy, among others. In some embodiments, the IQR, which is defined as the difference between the 75th and 25th percentile intensity values in the sample area, is more robust to outliers.

This uniformity analysis is computed for each patch using the metrics each time a new image is acquired by the camera 40 (FIG. 1). In some embodiments, the processor 54 in the computer 52 can optionally perform further computations or analysis to aggregate the non-uniformity values in the patches. For example, in some embodiments, the uniformity values of the patches are aggregated to determine an overall uniformity value for the area of interest. In some non-limiting embodiments, for example, patch uniformity values can be aggregated using mean, median, standard deviation, and the like. In another example, the uniformity values of a selected array of patches within the area of interest can be aggregated to provide a uniformity value for the area of interest. The median value of all the patch interquartile ranges is calculated to create an aggregate uniformity metric to rate the quality of the surface 24 for the selected variation of interest (for example, horizontal or vertical banding, orange peel, mottle and the like).

The image processing steps can then be repeated for each size scale s1, s2, . . . , and then optionally displayed on the display 56 (FIG. 1) as plots of uniformity vs. size scale. This is convenient in cases where the processing is performed offline, since the goal in this setting can be to compare different materials or formulations. However, in cases where the image processing technique of this disclosure is meant to be used online for real-time inspection on a production line, it may be more beneficial to display plots of uniformity vs. time, showing separate curves for a few different size scales of interest. For online processing, this allows for visualization of changes in uniformity over time during a production run, or between runs, in a control-chart format to assess the functionality of the surface 24 or the product of which the sample 18 is a part (FIG. 1).

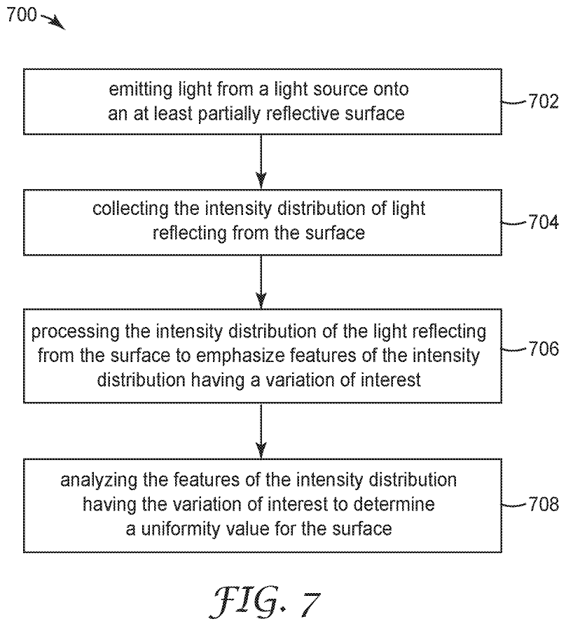

Referring to FIG. 7, in summary the method of the present disclosure 700 includes a first step 702 in which light is emitted from a light source onto an at least partially reflective surface. In step 704, light reflected from the reflective surface is captured to form an intensity distribution of the light reflected from the surface. In step 706, the intensity distribution is processed to emphasize features of the intensity distribution of the surface having a variation of interest. In step 708, the features of the intensity distribution having the variation of interest are analyzed to determine a uniformity value for the surface.

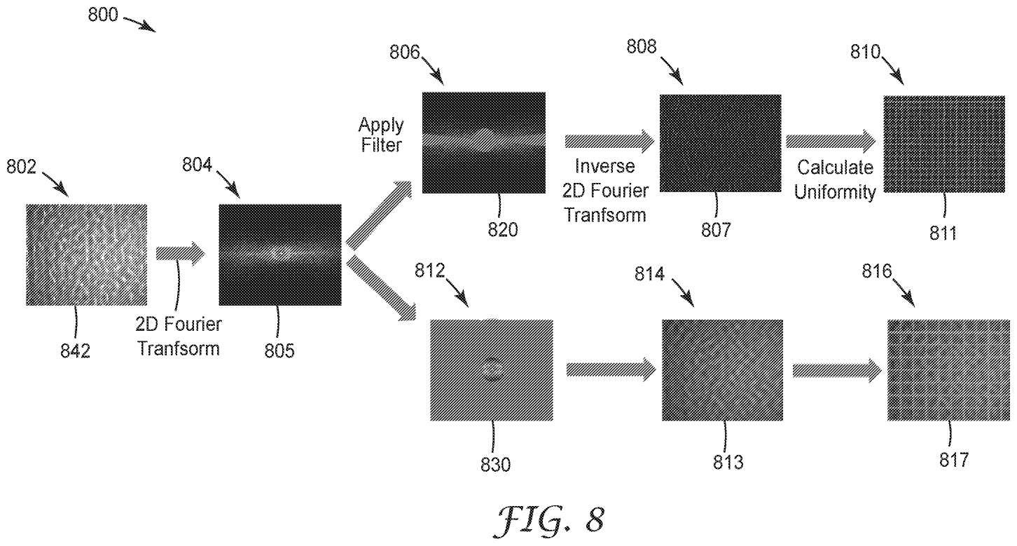

A more detailed description of an embodiment of the process of the present disclosure is shown in FIG. 8 (with reference also to the system of FIG. 1). In the process 800, in step 802 a first image 842 of an intensity distribution of light reflected off a surface containing both large and small scale mottle is captured in, for example, a camera. In step 804, the Fourier transform of the first image 842 is performed, typically by a processor in a computer with a properly configured software package, to obtain a Fourier transform image 805 of the image 842.

In step 806, to emphasize the smaller scale mottle (orange peel) in the Fourier transform, the Fourier transform 805 is filtered with the filter of FIG. 5B to obtain a filtered Fourier transform 820. In step 808, an inverse Fourier transform 807 of the filtered Fourier transform image 820 is obtained to emphasize the selected feature (for example, orange peel) in the image 805. In step 810, a uniformity rating 809 is obtained for the inverse Fourier transform image 807 by smoothing the inverse Fourier transform image 807, dividing the area into patches, and calculating a uniformity value within each patch.

In an alternative step 812, to emphasize the larger scale mottle in the Fourier transform, a low pass filter (FIG. 5A) is applied to the Fourier transform 805 of the original image 842 to obtain a filtered Fourier transform 830. In step 814, an inverse Fourier transform 813 of the filtered Fourier transform image 830 is performed to emphasize the orange peel in the image 842. In step 816, a large scale uniformity rating 817 is obtained for the image 813 by smoothing the inverse Fourier transform image 813, dividing the area into patches, and calculating a uniformity value within each patch.

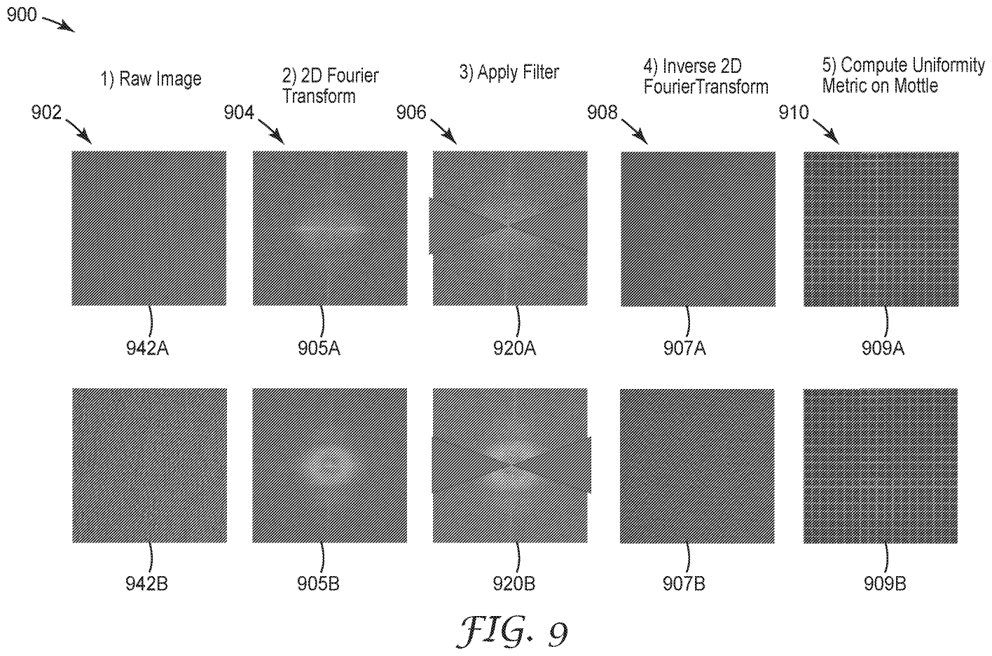

In another embodiment shown in FIG. 9, a process 900 includes a step 902 in which an intensity distribution of light reflected from surfaces under test is captured to obtain a first image 942A including vertical banding, and a second image 942B including small scale mottle (orange peel). In step 904, the Fourier transform of the images 942A and 942B is performed, typically by a processor in a computer with a properly configured software package, to obtain respective Fourier transform images 905A, 905B. In step 906, to emphasize the smaller scale mottle (orange peel) in the Fourier transform mages 905A, 905B, a filter (FIG. 4A) is applied to the Fourier transform images 905A, 905B to obtain filtered Fourier transform images 920A, 920B. In step 908, an inverse Fourier transform 907A, 907B of the filtered Fourier transform images 920A, 920B is obtained to emphasize the orange peel in the respective images 907A, 907B. In step 910, a surface uniformity rating 909A, 909B is obtained for the respective images 942A, 942B by smoothing the inverse Fourier transform images 907A, 907B to remove any variation that is smaller than the size scale of interest, dividing the area into patches, and calculating a uniformity value within each patch.

In one embodiment, the optical inspection systems shown in FIGS. 1-2 may be used within a manufacturing plant to apply the methods of the present disclosure (FIGS. 7-9) for detecting the presence of features such as selected types of non-uniformity defects in an at least partially reflective surface of an optical component. The inspection system may also provide output data that indicates a severity of each defect in real-time as the component is manufactured. For example, the computerized inspection systems may provide real-time feedback to users, such as process engineers, within manufacturing plants regarding the presence of non-uniformities and their severity, which can allow the users to quickly respond to an emerging non-uniformity by adjusting process conditions to remedy a problem without significantly delaying production or producing large numbers of unusable components. The computerized inspection system may apply algorithms to compute the severity level by ultimately assigning a rating label for the non-uniformity (e.g., “good” or “bad”) or by producing a measurement of non-uniformity severity of a given sample on a continuous scale or more accurately sampled scale.

The analysis computer 52, 152 (FIGS. 1-2) may store the feature dimension information for the surface 24, 174, including position information for each measured area of interest on the surface 24, 174, within a database 55, 155. For example, the analysis computer 52, 152 may utilize position data produced by a fiducial mark controller to determine the spatial position or image region of each measured feature within the coordinate system of the process line. That is, based on the position data from the fiducial mark controller, the analysis computer 52,152 determines the x, y, and possibly z position or range for each measured area of interest on the surface 24, 174 within the coordinate system used by the current process line.

The database 55,155 may be implemented in any of a number of different forms including a data storage file or one or more database management systems (DBMS) executing on one or more database servers. The database management systems may be, for example, a relational (RDBMS), hierarchical (HDBMS), multidimensional (MDBMS), object oriented (ODBMS or OODBMS) or object relational (ORDBMS) database management system. As one example, the database 55,155 is implemented as a relational database available under the trade designation SQL Server from Microsoft Corporation, Redmond, Wash.

Once the process has ended, the analysis computer 52, 152 may transmit the data collected in the database 55, 155 to a conversion control system 60, 160 via a network 65, 165. For example, the analysis computer 52, 152 may communicate the uniformity information and respective sub-images for each uniformity measurement to the conversion control system 60,160 for subsequent, offline, detailed analysis. For example, the uniformity information may be communicated by way of database synchronization between the database 55,155 and the conversion control system 60, 160.

In some embodiments, the conversion control system 60, 160 may determine those products for which each anomaly may cause a defect, rather than the analysis computer 52, 152. Once data for the finished web roll have been collected in the database 55, 155, the data may be communicated to converting sites and/or used to mark anomalies on the surface, either directly on the surface with a removable or washable mark, or on a cover sheet that may be applied to the surface before or during marking of anomalies thereon.

The components of the analysis computer 52, 152 may be implemented, at least in part, as software instructions executed by one or more processors of the analysis computer 52, 152, including one or more hardware microprocessors, digital signal processors (DSPs), application specific integrated circuits (ASICs), field programmable gate arrays (FPGAs), or any other equivalent integrated or discrete logic circuitry, as well as any combinations of such components. The software instructions may be stored within in a non-transitory computer readable medium, such as random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media.

Although shown for purposes of example as positioned within a manufacturing plant near the surface 24, 174 to be analyzed, the analysis computer 52, 152 may be located external to the manufacturing plant, e.g., at a central location or at a converting site. For example, the analysis computer 52, 152 may operate within the conversion control system 60, 160. In another example, the described components execute on a single computing platform and may be integrated into the same software system.

The optical inspection system and methods described herein may be used to detect the presence of surface defects in a wide variety of optical products having a surface that is at least partially reflective. In one example, which is not intended to be limiting, the optical inspection system is particularly well suited for rating the surface defects in reflective polarizer films mounted on a surface of a liquid crystal display, or laminated between multiple pieces of glass.

Embodiments will now be illustrated with reference to the following non-limiting examples.

### EXAMPLES

### Example 1

A total of 27 samples of reflective polarizer films were visually graded by three different quality appraisal experts. Each appraiser rated each sample on a scale of 1-8 for orange peel, and two randomized repeats of each human sample rating was performed. These samples were then imaged using the geometry of FIG. 1 and analyzed using the process described in FIG. 9. A filter similar to the one shown in FIG. 4A was applied to the 2D Fourier transform to eliminate a banding artifact present in some of the samples. The triangular nature of the filter allowed for some variance in how the samples are laminated, such that the banding artifacts did not have to be perfectly vertical. A single uniformity metric was then calculated for each sample to create a quantitative rating of the orange peel severity. This sample measurement procedure was repeated twice by two US operators to examine reproducibility and repeatability of the measurement method.

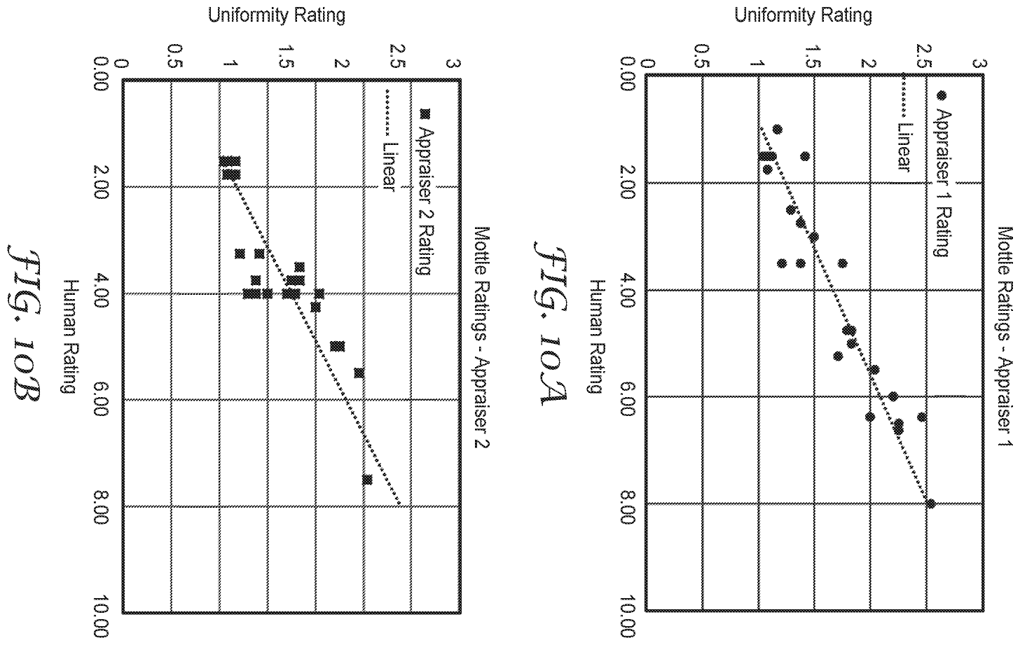

One of the advantages of using the digital image processing method of the present disclosure is that it removes variability amongst human ratings provided by different “expert appraisers.” This is illustrated in the plots of FIGS. 10A-10C. With the data shown this way, it is apparent that the three expert appraisers that visually rated the samples were effectively using separate scales for rating the severity of the variations. The correlation between the digital image processing method and the ratings given by any single appraiser are quite good, but the “calibration curves” that would correlate the uniformity rating from the digital image processing method to the expert ratings vary according to which experts are rating the samples. If the sample testing system and method described here is used in all locations, one could choose whether to use a single unified calibration curve to transfer the uniformity metric into a 1 to 8 scale range, or whether to average the calibration curves.

### Example 2

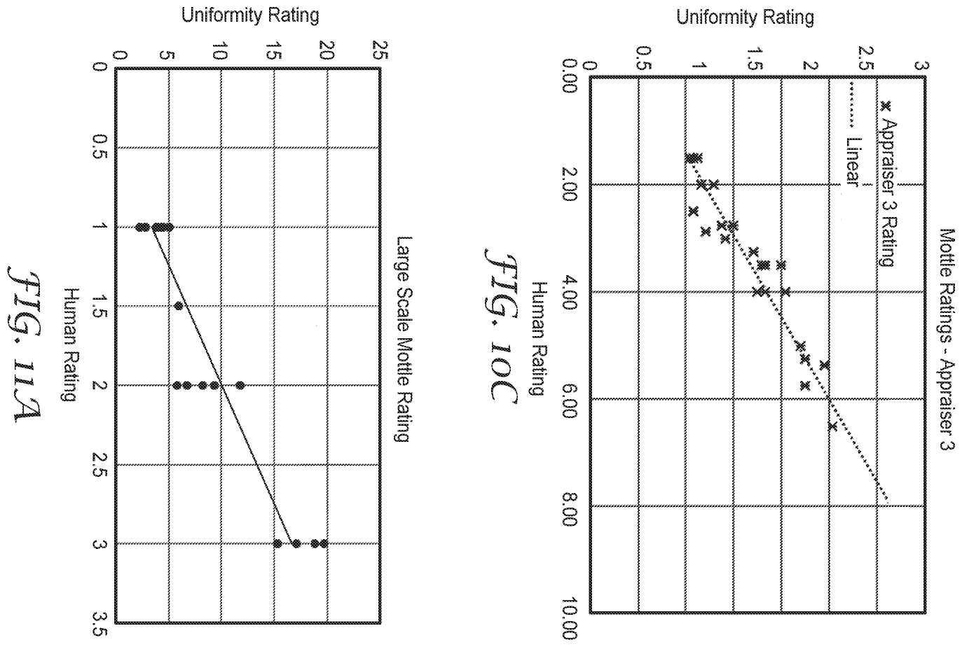

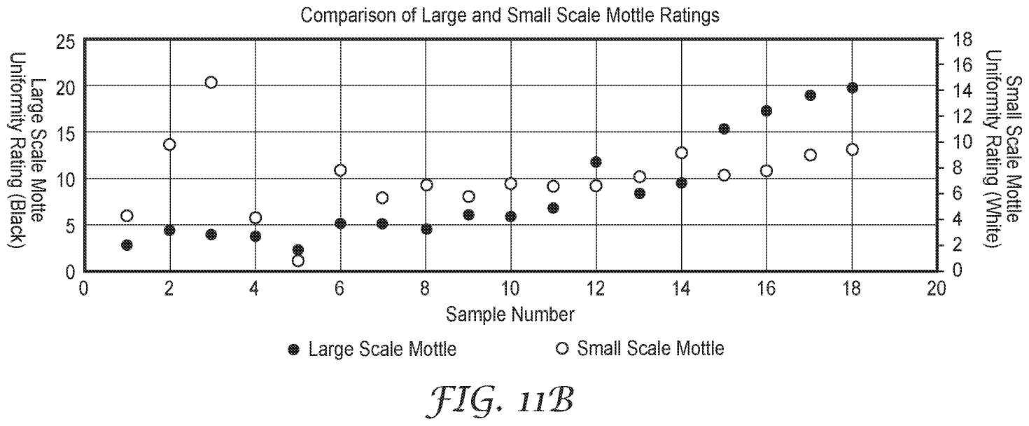

A similar testing procedure was followed using a set of 18 reflective polarizer film samples with larger scale mottle which were rated by several expert appraisers. The results obtained from the mottle inspection system shown in FIG. 2 and processed by the steps shown in FIG. 8 utilizing the filters shown in FIG. 5A is shown in FIG. 11A.

Referring to FIG. 11B, this method demonstrates the ability to separate the larger scale mottle variation from the smaller scale mottle variation, giving separate quantitative metrics for both. Only the larger scale mottle variation was rated by the human appraisers, so the correlation between human and machine ratings is shown in FIG. 11A. The smaller scale mottle (orange peel) and larger mottle rating are simply plotted vs sample number in FIG. 11B. There experts agreed that the relative ratings of the orange peel variations agreed with their impressions.

### EMBODIMENTS

A. A method, comprising:
   emitting light from a light source onto a surface, wherein the surface is at least partially reflective;
   collecting reflected light reflected from the surface to capture the intensity distribution of the reflected light;
   processing the intensity distribution of the reflected light to emphasize features of the intensity distribution of the reflected light having a variation of interest; and
   analyzing the features of the intensity distribution of the reflected light having the variation of interest to determine a uniformity value for the surface.
B. The method of Embodiment A, wherein the light source is spatially coherent.
C. The method of Embodiment A, wherein the light source comprises a point light source.
D. The method of any of Embodiments A-C, wherein light emitted from the light source is polarized.
E. The method of Embodiment C, wherein light emitted from the point light source is polarized.
F. The method of any of Embodiments A-E, wherein the reflected light is at least partially polarized.
G. The method of any of Embodiments A-F, wherein the reflected light is analyzed.
H. The method of any of Embodiments A-G, wherein the surface is an external surface of an optical component.
I. The method of any of Embodiments A-F, wherein the surface is an internal surface of an optical component.
J. The method of any of Embodiments A-I, wherein the reflected light is collected by directing the reflected light onto an imaging array.
K. The method of Embodiment J, wherein the reflected light is condensed by a lens or mirror prior to reaching the imaging array.
L. The method of any of Embodiments A-K, wherein the reflected light is collected by directing the reflected light onto a screen.
M. The method of Embodiment L, wherein the intensity distribution on the screen is imaged by a camera to form an image of the intensity distribution of the reflected light reflected from the surface.
N. The method of any of Embodiments A to M, wherein processing the intensity distribution of the reflected light comprises applying to an image of the intensity distribution a processing method chosen from: wavelet transforms, filtering, applying spatial convolution kernels, and combinations thereof
O. The method of Embodiment N, wherein the processing method comprises performing a Fourier transform of the image of the intensity distribution, and applying a filtering function to the Fourier transform to emphasize selected spatial frequencies in the image of the intensity indicative of properties of the surface.
P. The method of Embodiment O, wherein the Fourier transform is performed by at least one of an optical system, a field programmable gate array (FPGA), and a digital computer configured with software.
Q. The method of Embodiment P, wherein the Fourier transform is performed with the digital computer configured with software.
R. The method of Embodiment O, wherein the filtering function allows for rotational misalignment of the reflective surface or image of the intensity distribution.
S. The method of any of Embodiments A-R, wherein analyzing the feature of the intensity distribution having the variation of interest to determine a uniformity value for the surface comprises:
   performing a Fourier transform of an image of the intensity distribution of the reflected light from the surface;
   filtering the Fourier transform to obtain a filtered Fourier transform;
   performing an inverse Fourier transform of the filtered Fourier transform to obtain an inverse Fourier transform;
   analyzing regions of the inverse Fourier transform to determine contrast variations within the regions; and
   calculating uniformity values for each region of the inverse Fourier transform.
T. The method of Embodiment S, further comprising dividing the regions of the inverse Fourier transform into patches; and calculating a uniformity value within each patch.
U. The method of Embodiment T, further comprising aggregating the uniformity values for the patches to determine the uniformity value for the surface.
V. The method of Embodiment H, wherein the optical component is a reflective polarizer.
W. The method of Embodiment I, wherein the optical component is a reflective polarizer.
X. The method of Embodiment V, wherein the reflective polarizer comprises a multilayered polymeric film.
Y. The method of Embodiment V, wherein the reflective polarizer is adhered to a substrate to form a laminated sample.
Z. The method of Embodiment V, wherein the reflective polarizer is between two substrates to form a laminated sample, and wherein at least one of the two substrates is transparent to the wavelengths of light emitted by the light source.
AA. The method of Embodiment W, wherein the reflective polarizer comprises a multilayered polymeric film.
BB. The method of Embodiment W, wherein the reflective polarizer is adhered to a substrate to form a laminated sample.
CC. The method of Embodiment W, wherein the reflective polarizer is between two substrates to form a laminated sample, and wherein at least one of the two substrates is transparent to the wavelengths of light emitted by the light source.
DD. A method, comprising:
   emitting light from a point light source onto a surface of an optical component, wherein the surface is at least partially reflective;
   collecting reflected light from the surface on a screen to capture an intensity distribution of the reflected light;
   imaging the screen with a camera to form an image of the intensity distribution of the reflected light;
   performing a Fourier transform of the image of the intensity distribution of the reflected light;
   filtering the Fourier transform to obtain a filtered Fourier transform, wherein the filtering selects spatial frequencies in the image of the intensity distribution indicative of a defect in the surface;
   performing an inverse Fourier transform of the filtered Fourier transform to obtain an inverse Fourier transform;
   analyzing regions of the inverse Fourier transform to determine contrast variations within the regions; and
   calculating uniformity values for the defect in each region of the inverse Fourier transform.
EE. The method of Embodiment DD, further comprising dividing the regions of the inverse Fourier transform into patches; and calculating a uniformity value within each patch.
FF. The method of Embodiment EE, further comprising aggregating the uniformity values for the patches to determine the uniformity value for the surface.
GG. The method of Embodiments DD-FF, wherein the optical component is a reflective polarizer.
HH. A system for determining the uniformity value for a surface of an optical component, the system comprising:
   an optical component comprising an at least partially reflective surface; and
   an apparatus, the apparatus comprising:
   a point source emitting light onto the surface of the optical component;
   a screen positioned to collect reflected light reflected from the surface of the optical component and capture an intensity distribution of the reflected light;
   a camera positioned to image the screen and capture an image of the intensity distribution of the reflected light; and
   a computer comprising a processor configured to:
   perform a Fourier transform of the image of the intensity distribution of the reflected light;
   filter the Fourier transform to obtain a filtered Fourier transform, wherein the filter is applied to select spatial frequencies in the image of the intensity distribution indicative of a defect in the surface;
   perform an inverse Fourier transform of the filtered Fourier transform to obtain an inverse Fourier transform;
   analyze regions of the inverse Fourier transform to determine contrast variations within the regions; and
   calculate uniformity values for the defect for each region of the inverse Fourier transform.
II. The method of Embodiment HH, further comprising dividing the regions of the inverse Fourier transform into patches; and calculating a uniformity value within each patch.
JJ. The method of Embodiment II, further comprising aggregating the uniformity values for the patches to determine the uniformity value for the surface.
KK. The system of any of Embodiments HH-JJ, wherein the optical component is a reflective polarizer.
LL. The system of Embodiment KK, wherein the reflective polarizer comprises a multilayered polymeric film.
MM. The system of Embodiment KK, wherein the reflective polarizer is adhered to a substrate to form a laminated sample.
NN. The system of Embodiment KK, wherein the reflective polarizer is between two substrates to form a laminated sample, and wherein at least one of the two substrates is transparent to the wavelengths of light emitted by the light source.
OO. The system of any of Embodiments HH-NN, wherein the filter accentuates the selected spatial frequencies in the Fourier transform of the image of the surface indicative of a defect in the surface.
PP. The system of any of Embodiments HI-I-OO, wherein the filter suppresses the selected spatial frequencies in the Fourier transform of the image of the surface indicative of a defect in the surface.

Various embodiments of the invention have been described. These and other embodiments are within the scope of the following claims.

1. A method, comprising:
emitting light from a light source onto a surface, wherein the surface is at least partially reflective;
collecting reflected light reflected from the surface to capture the intensity distribution of the reflected light;
processing the intensity distribution of the reflected light to emphasize features of the intensity distribution of the reflected light having a variation of interest; and
analyzing the features of the intensity distribution of the reflected light having the variation of interest to determine a uniformity value for the surface.

2. The method of claim 1, wherein the light source comprises a point light source.

3. The method of claim 2, wherein light emitted from the light source is polarized.

4. The method of claim 1, wherein the reflected light is analyzed.

5. The method of claim 1, wherein the reflected light is collected by directing the reflected light onto a screen.

6. The method of claim 5, wherein the intensity distribution on the screen is imaged by a camera to form an image of the intensity distribution of the reflected light reflected from the surface.

7. The method of claim 1, wherein processing the intensity distribution of the reflected light comprises applying to an image of the intensity distribution a processing method chosen from: wavelet transforms, filtering, applying spatial convolution kernels, and combinations thereof

8. The method of claim 7, wherein the processing method comprises performing a Fourier transform of the image of the intensity distribution, and applying a filtering function to the Fourier transform to emphasize selected spatial frequencies in the image of the intensity indicative of properties of the surface.

9. The method of claim 8, wherein the Fourier transform is performed by at least one of an optical system, a field programmable gate array (FPGA), and a digital computer configured with software.

10. The method of claim 1, wherein analyzing the feature of the intensity distribution having the variation of interest to determine a uniformity value for the surface comprises:
performing a Fourier transform of an image of the intensity distribution of the reflected light from the surface;
filtering the Fourier transform to obtain a filtered Fourier transform;
performing an inverse Fourier transform of the filtered Fourier transform to obtain an inverse Fourier transform;
analyzing regions of the inverse Fourier transform to determine contrast variations within the regions; and
calculating uniformity values for each region of the inverse Fourier transform.

11. The method of claim 10, further comprising dividing the regions of the inverse Fourier transform into patches; and calculating a uniformity value within each patch.

12. The method of claim 11, further comprising aggregating the uniformity values for the patches to determine the uniformity value for the surface.

13. A system for determining the uniformity value for a surface of an optical component, the system comprising:
an optical component comprising an at least partially reflective surface; and
an apparatus, the apparatus comprising:
a point source emitting light onto the surface of the optical component;
a screen positioned to collect reflected light reflected from the surface of the optical component and capture an intensity distribution of the reflected light;
a camera positioned to image the screen and capture an image of the intensity distribution of the reflected light; and
a computer comprising a processor configured to:
perform a Fourier transform of the image of the intensity distribution of the reflected light;
filter the Fourier transform to obtain a filtered Fourier transform, wherein the filter is applied to select spatial frequencies in the image of the intensity distribution indicative of a defect in the surface;
perform an inverse Fourier transform of the filtered Fourier transform to obtain an inverse Fourier transform;
analyze regions of the inverse Fourier transform to determine contrast variations within the regions; and
calculate uniformity values for the defect for each region of the inverse Fourier transform.

14. The method of claim 13, further comprising dividing the regions of the inverse Fourier transform into patches; calculating a uniformity value within each patch, and aggregating the uniformity values for the patches to determine the uniformity value for the surface.

15. The system of claim 13, wherein the optical component is a reflective polarizer.
